(19) United States
(12) Patent Application Publication
(10) Pub. No.: US 2021/0375151 A1
(43) Pub. Date: Dec. 2, 2021

(54) Method and Apparatus for Teaching Using a Machine Learning Algorithm

(71) Applicant: Soffos, Inc., Austin, TX (US)

(72) Inventors: Nick Kairinos, Limassol (CY); Petros Mina, Nicosia (CY)

(73) Assignee: Soffos, Inc., Austin, TX (US)

(21) Appl. No.: 17/329,958

(22) Filed: May 25, 2021

Related U.S. Application Data
(60) Provisional application No. 63/033,454, filed on Jun. 2, 2020.

(51) Int. Cl. G09B 7/02; G06N 20/00; G06N 5/04

(52) U.S. Cl. CPC G09B 7/02; G06N 5/04; G06N 20/00

(57) ABSTRACT

A method for teaching a student a selected content using a computer implemented machine learning algorithm. After the selected content has been presented, a query is presented to the student relating to that content. A correctness metric is developed as a function of the response of the student to the query. From the correctness metric, an inference is made of the comprehension by the student of that content. During this process, physiological indicia of the response of the student are used to develop a behavioral pattern. Using the pattern, additional content may be selected for presentation to the student. Over time, the machine learning algorithm is able iteratively to make improved inferences of the preferred learning method of the student as a function of the inferred comprehension of the student of each newly presented content.

### BACKGROUND

### 1. Field

The present disclosure relates to a method and apparatus for teaching using a machine learning algorithm.

### 2. Description of the Related Art

In general, in the descriptions that follow, we will italicize the first occurrence of each special term of art that should be familiar to those skilled in the art of computer implemented algorithms, and, in particular, machine learning algorithms. In addition, when we first introduce a term that we believe to be new or that we will use in a context that we believe to be new, we will bold the term and provide the definition that we intend to apply to that term.

Hereinafter, when we refer to a facility we mean a circuit or an associated set of circuits adapted to perform a particular function regardless of the physical layout of an embodiment thereof. Thus, the electronic elements comprising a given facility may be instantiated in the form of a hard macro adapted to be placed as a physically contiguous module, or in the form of a soft macro the elements of which may be distributed in any appropriate way that meets speed path requirements. In general, electronic systems comprise many different types of facilities, each adapted to perform specific functions in accordance with the intended capabilities of each system. Depending on the intended system application, the several facilities comprising the hardware platform may be integrated onto a single integrated circuit (“IC”), or distributed across multiple ICs. Depending on cost and other known considerations, the electronic components, including the facility-instantiating IC(s), may be embodied in one or more single- or multi-chip packages. However, unless we expressly state to the contrary, we consider the form of instantiation of any facility that practices our disclosed embodiments as being purely a matter of design choice.

Education is the process of facilitating learning, or the acquisition of knowledge, skills, values, beliefs, and habits. Educational methods include storytelling, discussion, teaching, training, and directed research. Education frequently takes place under the guidance of educators, but learners may also educate themselves. Education can take place in formal or informal settings, and any experience that has a formative effect on the way one thinks, feels, or acts may be considered educational.

Existing education systems tend to follow the “one teacher, one room, one chalkboard” method of teaching, which is no longer appropriate as each learner has their own learning capabilities, and is influenced by their upbringing and background. For many centuries, mankind has struggled to address the above problem of teaching the same content to different learners who have different learning capabilities.

In recent years, practitioners in the health care industry have developed a teach-back method to confirm that a patient understands some selected information that has been presented to them by a practitioner. In accordance with this method, in response to a request from the practitioner, the patient teaches that specific information back to the practitioner. If a patient understands, he is able to “teach back” the information accurately. This process is generally believed to be effective in confirming understanding of the presented information.

Over the years, many on-line teaching software programs have been developed for teaching lessons to a learner. However, most of these teaching programs are not effective as they teach an entire topic automatically by presenting it to the learner. The learner may not gain any knowledge or understand the basis of the topic by simple exposure of the information around the topic by the on-line teaching software programs. To alleviate this problem and to improve the teaching process, many different methods have been developed over the years. One such method provides an international, utterly democratic open learning system covering any topic imaginable, which enables anyone to access it for free from anywhere. However, this method is not effective as it does not personalize lessons according to the learner's preferred mode of understanding.

Therefore, in light of the foregoing, there exists a need to address, for example to overcome, the aforementioned drawbacks in existing methods and systems due to their inability to assess accurately the knowledge of a given learner on a topic and provide personalized lessons on the topic according to the learner's preferred mode of understanding.

### BRIEF SUMMARY OF THE DISCLOSED EMBODIMENTS

In accordance with our disclosed embodiments, we provide a method of teaching a student, Student_1, using an electronic data processing facility configured to execute a software program adapted to implement a selected machine learning algorithm. In one embodiment, our method comprises using the data processing facility to perform the steps of: presenting to the Student_1 to a first content, Content_1; developing a first behavioural pattern, Pattern_1, as a function of the physical reaction of the Student_1 to the Content_1, wherein the Pattern_1 comprises a selected one of an Emotional_State of the Student_1 and a Biometric measurement of the Student_1; developing a first Query, Query_1, as a function of the Content_1 and the Pattern_1; presenting to the Student_1 the Query_1; receiving from the Student_1 a first Response, Response_1, to the Query_1; and developing a first correctness metric, Correctness_1, as a function of the Content_1, the Pattern_1, the Query_1 and the Response_1.

In accordance with another embodiment, our method includes the step of inferring, using the machine learning algorithm, a first comprehension inference, Comprehension_1, as a function of the Correctness_1, wherein the Comprehension_1 comprises an inference of the comprehension by the Student_1 of the Content_1.

In accordance with a further embodiment, our method can be performed recursively, thereby allowing our machine learning algorithm to infer a first model, Model_1, as a function of the Correctness_1 and, e.g., a second correctness metric, Correctness_2, wherein the Model_1 comprises a first inferred model of a preferred learning method of the Student_1.

In accordance with yet another embodiment of our present disclosure, an electronic data procession system may be configured to practice our teaching methods.

In accordance with still another embodiment of our present disclosure, a non-transitory computer readable medium may include executable instructions which, when executed in a processing system, causes the processing system to perform the steps of our teaching methods.

### BRIEF DESCRIPTION OF THE SEVERAL VIEWS OF THE DRAWINGS

Our disclosed embodiments may be more fully understood by a description of certain preferred embodiments in conjunction with the attached drawings in which:

FIG. 1 is a schematic illustration of a system in accordance with an embodiment of the present disclosure;

FIG. 2 is a functional block diagram of a system in accordance with an embodiment of the present disclosure;

FIG. 3 is an exemplary view of a graphical user interface that shows a Content that is accessed by a Student in accordance with an embodiment of the present disclosure;

FIG. 4 is an exemplary view of a graphical user interface that provides a first Query related to a Content accessed by a Student in accordance with an embodiment of the present disclosure;

FIG. 5 is an exemplary view of a graphical user interface that provides a knowledge assessment of a Student in accordance with an embodiment of the present disclosure; and

FIGS. 6A to 6B are flow diagrams illustrating a method of autonomous learning and dynamically adapting teaching of a Content based on a level of understanding of a Student on the Content using a machine learning algorithm in accordance with an embodiment of the present disclosure.

### DETAILED DESCRIPTION OF THE EMBODIMENTS

For convenience of reference, we shall hereafter use the following capitalized terms:
Algorithm means a process flow implemented in the form of computer software in a selected one or more of the currently available programming languages;
Biometric means a metric comprising a digital representation of a biological measurement of a Student while receiving Content
Comprehension means an Inference of the comprehension of a Content by a Student;
Correctness means a metric comprising a digital representation of the correctness of a Response;
Content means information relating to a selected one or more topics;
Emotional_State means a metric comprising a digital representation of selected physical Responses of a Student to receiving Content;
Inference means a prediction made by a MLA as a function of a data set presented to the MLA;
Machine_Learning Algorithm (“MLA”) means a computer implemented Algorithm adapted to develop Inferences as a function of a selected set of training data;
Model means an Inference of the preferred learning method of a Student;
Pattern means an Inference of the state of mind of a Student as a function of at least one of an Emotional_State and a Biometric;
Query means a query presented to a Student;
Reason means a justification of a Response submitted by a Student in Response to a Request;
Request means a request presented to a Student for either a Response or a Reason;
Response means an answer submitted by a Student in response to a Query;
Student means a human who has, voluntarily, agreed to receive Content, e.g.: a student enrolled in an institute of learning; a learner who, for personal reasons, desires to receive the Content; a researcherwho, for professional reasons, seeks knowledge of the Content; a teacher who, for professional reasons, desires to enhance their understanding of the Content; or an employee who, because of their job within a company, is expected to know the Content
Teach_Back is a Request relating to a selected aspect of a Content that has been presented to a Student; and
Teacher means a human who, by reason of superior understanding of some Content, has been accepted by a Student as a source of that Content, e.g.: a parent or other respected member of the family of the Student; a teacher engaged by an institute of learning; a tutorwho has been accepted by a Student as a private source of that Content; a mentor who has been accepted by a Student as a trusted advisor with respect to that Content; or a provider of Content accepted by the Student.

The following detailed description illustrates embodiments of the present disclosure and ways in which they can be implemented. Although we will disclose some modes of carrying out the present disclosure, those skilled in the art will recognize that other embodiments for carrying out or practicing the present disclosure are also possible.

In general, our disclosed embodiments provides a method of autonomous learning and dynamically adapting teaching of a Content based on a level of understanding of a Student on the Content using a Machine_Learning Algorithm executing upon a data processing facility, characterized in that the method comprises the following steps:
generating a first Content that is accessed by a Student;
determining a behavioural Pattern of the Student while accessing the first Content, wherein the behavioural Pattern comprises a selected one of an Emotional_State and a Biometric of the Student;
generating a test comprising a first Query for the Student as a function of the first Content and a selected one of the Emotional_State and the Biometric of the Student;
processing a first Response from the Student to the first Query;
determining a Correctness of the first Response;
providing to the MLA the first Response, the Correctness of the first Response, and a selected one of the Emotional_State and a Biometric of the Student;
using the MLA to determine a Teach_Back for the Student as a function of the first Content and the Correctness of the first Response;
processing a second Response from the Student to the Teach_Back;
using the MLA to determine a level of understanding of the Student of the first Content as a function of the first Response, the Correctness of the first Response, the second Response and the Correctness of the second Response;
using the MLA to infer a preferred mode of teaching for the Student as a function of the level of understanding of the Student on the first Content;
using the MLA to determine a second Content related to the first Content as a function of the Student's preferred mode of teaching; and
enabling the Student to access the second Content selected as a function of the level of understanding of the Student on the first Content.

The present method dynamically provides personalized Content for adaptive teaching based on a level of understanding of a Student on a topic, e.g., a Content, by assessing a level of understanding of the Student on the topic. The present method assesses the level of understanding of the Student on the topic by providing one or more Queries to the Student. The present method provides a secondary Content related to the topic to help the Student to dynamically improve his level of understanding of the topic. The present method helps to determine strengths and weaknesses of the Student on the topic. The present method further provides a personalized Content or a Teach_Back related to the topic based on a preferred teaching mode of the Student. The present method further utilizes the Internet-connected MLA to build an independent platform to connect potential and existing Students with Teachers. The present method may update the Student about a progress of learning and, more importantly, the present method identifies, at an early stage, learning difficulties of the Student.

In an embodiment, the secondary Content may be obtained from at least one of the knowledge base repository, a device associated with a Teacher, or a plurality of live servers. The present method may enable the Teacher to assess the level of understanding of the Student on the primary Content, using the MLA, and provide to the Student the secondary Content and the Teach_Back based on his assessment. The present method may enable the Teacher to rate the Student based on the level of understanding of the Student on the primary Content, using the MLA. The present method may enable the Teacher to provide real time feedback to the Student when the Student is learning more about the primary Content. The present method may update the level of understanding of the Student on the primary Content in the database based on the rating provided by the Teacher using the MLA. The present method may enable the Student to rate the Teacher based on the secondary Content and the Teach_Back provided by the Teacher using the MLA. The present method may provide ratings or rewards (e.g., price) to the Teacher based on a performance of the Teacher over a period of time.

The present method may assess a level of understanding of the Student on the secondary Content, using the MLA, and provide subsequent secondary Content to the Student to improve the level of understanding on the topic.

The present method may assess a level of engagement of the Student using at least one of the primary Content, the secondary Content, the Teach_Back or the plurality of Queries related to the primary Content by the Student.

In an embodiment, the MLA may include a self-dynamically driven Algorithm which may be used to autonomously learn and adapt teaching as a function of the level of understanding of the Student dynamically. In an embodiment, the secondary Content in a preferred mode of teaching for the Student may be dynamically selected based upon a profile of the Student (e.g., based upon educational details of the Student). The preferred mode of teaching may be determined based on the level of engagement of the Student.

In an embodiment, the MLA determines the Correctness of the Response by comparing the Responses from other Students for the plurality of Queries that is associated with a selected one of the first Content and the secondary Content provided by the system.

In an embodiment, the primary Content that is accessed by the Student may be stored in an external database. In an embodiment, a test includes: a Query on the Content; or a Request for a Teach_Back. The test may include multiple choice Queries comprising at least one correct answer. The secondary Content may be updated in the database based on at least one of the Teach_Back or the behavioural Pattern of the Student when: (i) accessing the first Content; (ii) accessing the secondary Content; and (iii) responding to the plurality of Queries, by the Student. In an embodiment, the preferred mode of teaching may be updated in the database based on at least one of the Teach_Back or the behavioural Pattern of the Student when: (i) accessing the first Content; (ii) accessing the secondary Contents; or (iii) responding to the plurality of Queries.

According to an embodiment, the Correctness of the Response to the first Query is determined by: (i) determining whether the Response to the first Query by the Student is correct in a first attempt; (ii) if the Student changes the Response to the first Query after the first attempt, if the Response from the Student to the first Query is correct; and (iii) determining a time taken to respond to the first Query by the Student.

According to another embodiment, the method comprises processing a Reason for the Response provided to the first Query by the Student, and aggregating Responses to the same first Query by other Students, if the Response from the Student to the first Query is wrong.

According to yet another embodiment, the method comprises providing the second Query to the Student using the Student device. In an embodiment, the graphical user interface may be used to: (a) implement at least one test; and (b) obtain a plurality of the Student Responses.

According to yet another embodiment, the method comprises enabling the Teacher to assess the level of understanding of the Student to provide the secondary Content in a preferred mode of teaching for the Student based on the level of understanding of the Student.

According to yet another embodiment, the method comprises updating the database with the secondary Content provided to the Student. The present method may aggregate the secondary Content that is provided to the Student and update the first knowledge base repository to determine the preferred mode of teaching for the Student.

According to yet another embodiment, the method comprises translating in real time: the test; the Request for a Teach_Back; or the secondary Content.

In an embodiment, the method comprises determining the behavioural Pattern of the Student by analyzing the Students engagement to the primary Content. In an embodiment, the present method may detect a trauma or a behavioural Pattern of the Student based on the psychological parameters of the Student or a voice of the Student. The psychological parameters and the voice of the Student may be measured using sensors. The voice of the Student may be processed using a voice recognition technique to detect the trauma (e.g., emotion) of the Student based on his voice. The present method alerts the Teacher (and, perhaps, the MLA) for determining a personalised teaching if the trauma of the Student exceeds a threshold value or a change in behavioural Pattern of the Student. In an embodiment, the present method may provide a gamification Content related to the primary Content to the Student if the trauma of the Student is bad.

According to yet another embodiment, at least one of the records, the history, the Emotional_State or Biometric of the Student is obtained from the Student. The Biometric includes at least one of face features, voice features or posture features.

In an example embodiment, at least one test related to the primary Content that is accessed by the Student is provided to the Student. A Response from the Student for the first Query and the level of understanding of the Student on the primary Content that is accessed by the Student is recorded in the database. Based upon the Response and the level of understanding of the Student on the primary Content, the MLA may determine a next optimal piece of knowledge (e.g., the secondary Content) to transfer in order to guide the Student's knowledge retention towards a threshold on the primary Content. In one embodiment, the test is provided to the Student to determine a level of understanding on the primary Content using the MLA. The determination of the level of understanding may help the Student to improve his knowledge on the particular primary Content and may also help the Student to enhance his preparation for exams.

In an embodiment, the present method may issue certificates to the Student based on his level of understanding of the primary Content. In an embodiment, the present method implements a blockchain based system for operations to carry through with transactions such as at least one of payments or the issue of certificates. The blockchain enables the Student to enter into a transparent and a provenance transaction. The blockchain further enables the Student to implement an independent transaction with another user, e.g., another Student, a Teacher, etc. The blockchain creates custom cryptocurrencies to handle grant or voucher-based funders of education in many countries. The blockchain stores records of the transaction related to the users and the records are isolated from modification. In an embodiment, the blockchain automatically verifies a validity of a certificate associated with the Student that is issued by an educational organisation without an intervention of the educational organisation. The blockchain determines an extent and a speed of progress associated with an increasing level of understanding of the Student on the primary Content either forward or backward.

The present disclosure also provides an electronic data processing system comprising:
a processor; and
a memory configured to store:
a database of primary Content adapted to be accessed by a Student; and
program codes adapted to configure the processor to perform a Machine_Learning Algorithm comprising the following steps:
generating a first Content that is accessed by a Student;
determining a behavioural Pattern of the Student while accessing the first Content, wherein the behavioural Pattern comprises a selected one of an Emotional_State and a Biometric of the Student;
generating a test comprising a first Query for the Student as a function of the first Content and a selected one of the Emotional_State and the Biometric of the Student;
processing a first Response from the Student to the first Query;
determining a Correctness of the first Response;
providing to the MLA the first Response, the Correctness of the first Response, and a selected one of the Emotional_State and a Biometric of the Student;
using the MLA to determine a Teach_Back for the Student as a function of the first Content and the Correctness of the first Response;
processing a second Response from the Student to the Teach_Back;
using the MLA to determine a level of understanding of the Student of the first Content as a function of the first Response, the Correctness of the first Response, the second Response and the Correctness of the second Response;
using the MLA to infer a preferred mode of teaching for the Student as a function of the level of understanding of the Student on the first Content;
using the MLA to determine a second Content related to the first Content as a function of the Student's preferred mode of teaching; and
enabling the Student to access the second Content selected as a function of the level of understanding of the Student on the first Content.

In an embodiment, both the Teach_Back and the preferred mode of teaching the Student based on the level of understanding of the Student are developed using the MLA.

The advantages of the present system are thus identical to those disclosed above in connection with the present method, and the embodiments listed above in connection with the method apply mutatis mutandis to the system.

Embodiments of the present disclosure may eliminate the limitations in autonomous learning and dynamically adapting teaching of a Content related to a topic based on a level of understanding of a Student on the topic by assessing a level of understanding of the Student on the topic. The embodiments of the present disclosure may provide a personalized Content related to the topic in a preferred mode of teaching for the Student based on the level of understanding of the Student. The embodiments of the present disclosure may update the Student about a progress of learning, and, more importantly, the present method identifies at an early stage learning difficulties of the Student.

### DETAILED DESCRIPTION OF THE DRAWINGS

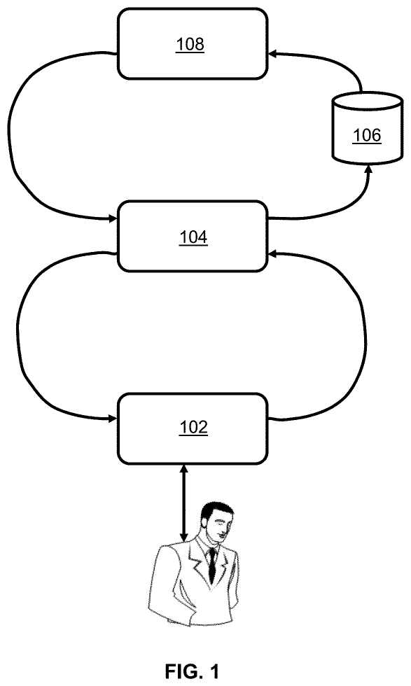

FIG. 1 is a schematic illustration of a system in accordance with an embodiment of the present disclosure. The system comprises a graphical user interface 102, a server 104, a server database 106 and a machine learning facility 108. The server 104 generates a database with a Content that is accessed by a Student. The server 104 generates a test that includes a plurality of Queries for the Student based on the primary Content and at least one of an Emotional_State or a Biometric of the Student. The server 104 processes a Response from the Student with reference to a first Query provided using the graphical user interface 102. The server 104 may store the Response to the first Query in the server database 106. In an embodiment, the server 104 comprises the server database 106 and the machine learning facility 108. The server 104 determines a Correctness of the Response from the Student to the first Query using the machine learning facility 108. The Response from the Student may be provided to the machine learning facility 108. The machine learning facility 108 is adapted to perform a Machine_Learning Algorithm. The MLA determines a Teach_Back, from the primary Content, for the Student based on the Correctness of the Response from the Student to the first Query. In response to receiving a Teach_Back from the Student, the MLA determines a level of understanding of the Student on the primary Content by aggregating the first Response and the Teach_Back from the Student, and developing a probability of success as a function of the first Response and the Teach_Back from the Student. The MLA determines a secondary Content or the Teach_Back in a preferred mode of teaching for the Student based on the level of understanding of the Student on the primary Content. The machine learning facility 108 may communicate the secondary Content to the server 104. The server 104 provides the secondary Content to the Student through the graphical user interface 102.

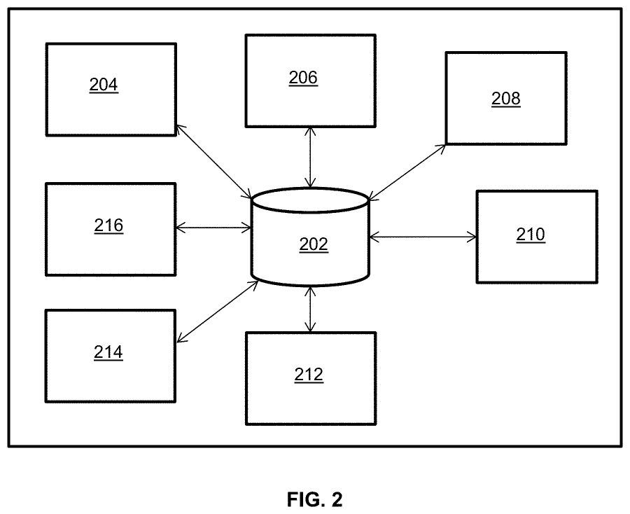

FIG. 2 is a functional block diagram of the system in accordance with an embodiment of the present disclosure. The functional block diagram of the system comprises a database 202, a behavioural Pattern determination module 204, a test generation module 206, a Response processing module 208, an correctness determination module 210, a Teach_Back determination module 212, a knowledge determination module 214 and an secondary Content determination module 216. These modules function as has been described above.

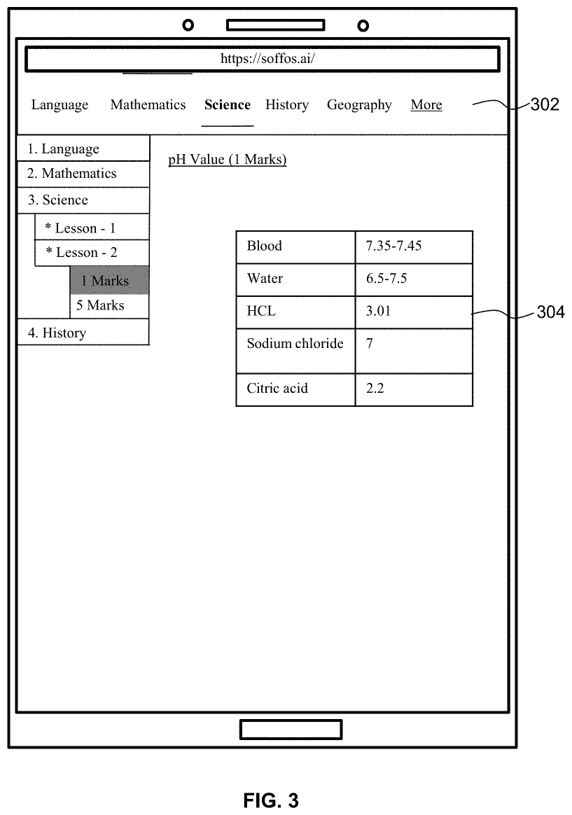

FIG. 3 is an exemplary view of a graphical user interface 302 that shows a Content that is accessed by a Student in accordance with an embodiment of the present disclosure. The graphical user interface 302 shows the Content that is accessed by the Student. The Content that is accessed by the Student includes a table 304 that provides a potential Hydrogen (pH) value of blood, water, hydrochloric acid, sodium chloride and citric acid. The primary Content and at least one of records, history or preferences of the Student is communicated to a server, using a Student device associated with the Student, to generate a test for the Student based on the primary Content.

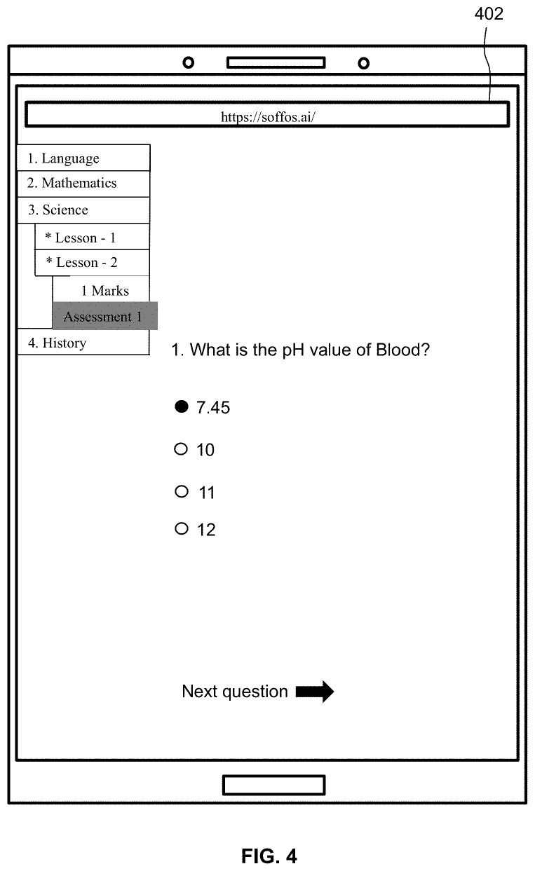

FIG. 4 is an exemplary view of a graphical user interface 402 that provides a first Query related to a Content accessed by a Student in accordance with an embodiment of the present disclosure. The graphical user interface 402 provides a first Query (e.g., what is the pH value of Blood?) to the Student based on the primary Content and at least one of records, history, an Emotional_State or a Biometric of the Student. The graphical user interface 402 may provide at least one of more than one choice for the first Query (e.g., 7.45, 10, 11, 12) or Teach_Back options to the Student to receive a Response (e.g., an answer) to the first Query. The Response to the first Query is processed by a system to determine a Correctness of the Response from the Student to the first Query and to determine a level of understanding of the Student on the primary Content.

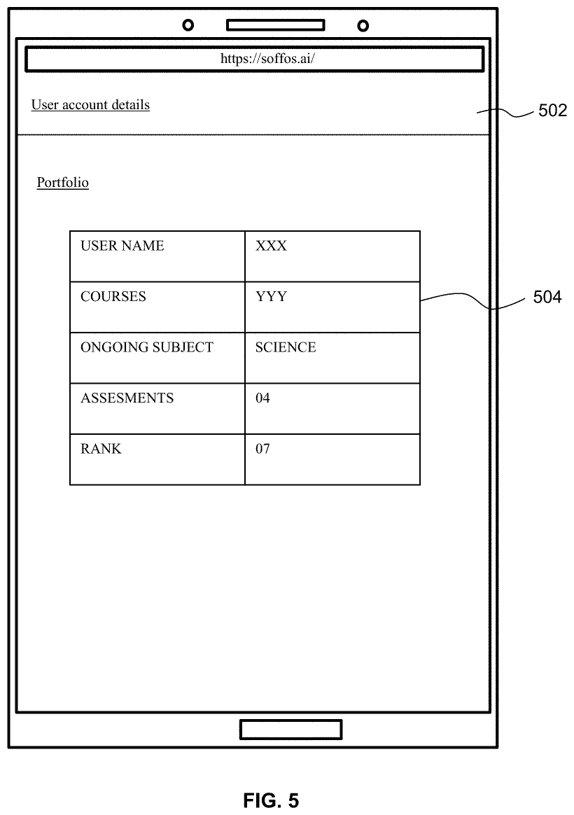

FIG. 5 is an exemplary view of a graphical user interface 502 that provides a knowledge assessment of a Student in accordance with an embodiment of the present disclosure. The graphical user interface 502 provides details related to a level of understanding (e.g., in terms of ranking or scaling) of the Student on a Content that is accessed by the Student. The graphical user interface 502 comprises a user account tab 504 that includes details of at least one of information related to the Student, a subject associated with the Content accessed by the Student, a number of assessment tests completed, a level of understanding of the Student on the Content accessed by the Student.

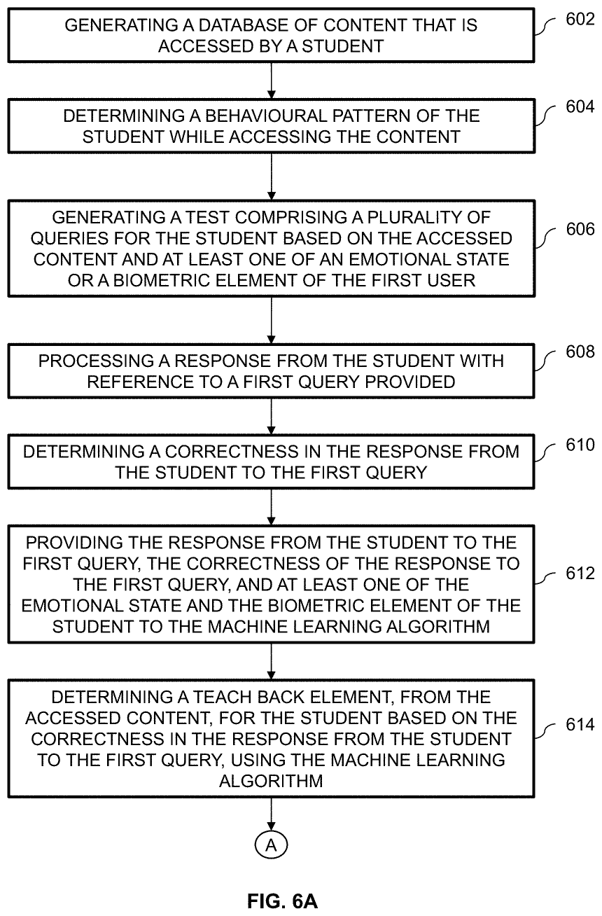

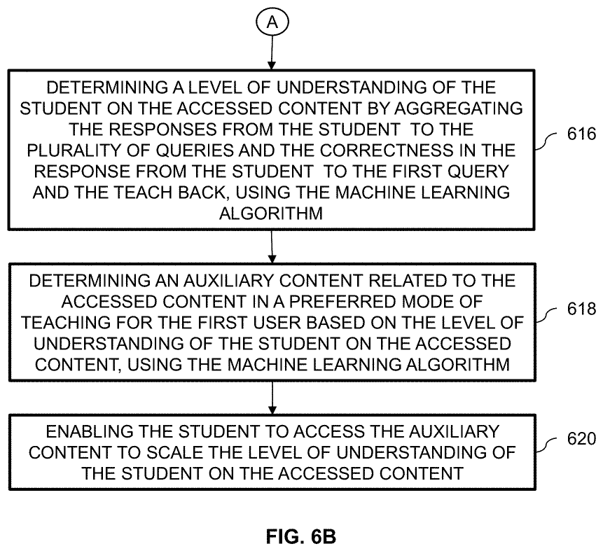

FIGS. 6A to 6B are flow diagrams illustrating a method of autonomous learning and dynamically adapting teaching of a Content based on a level of understanding of a Student on the Content using a MLA in accordance with an embodiment of the present disclosure. At a step 602, a database of a Content that is accessed by a Student is generated. At a step 604, a behavioural Pattern of the Student while accessing the Content is determined. The behavioural Pattern comprises at least one of an Emotional_State or a Biometric of the Student. At a step 606, a test comprising a plurality of Queries for the Student is generated based on the primary Content and at least one of records, history, the Emotional_State or the Biometric of the user. At a step 608, a Response from the Student with reference to a first Query provided using a graphical user interface of a Student device is processed. At a step 610, a Correctness of the Response from the Student to the first Query is determined. At a step 612, the Response from the Student to the first Query, the Correctness of the Response to the first Query and at least one of the Emotional_States and the Biometrics of the Student is provided to the MLA. At a step 614, a Teach_Back for the Student is determined based on the Correctness of the Response from the Student to the first Query, using the MLA. At step 616, a level of understanding of the Student on the accessed Content is determined, by aggregating the Responses from the Student to the plurality of Queries and the Correctness in the Responses from the Student to the first query and the teach back, using the MLA. At a step 618, an auxiliary Content related to the accessed Content in a preferred mode of teaching for the Student is determined based on the level of understanding of the Student on the accessed Content, using the MLA. At a step 620, the Student is enabled to access the auxiliary Content to scale the level of understanding of the Student on the accessed Content.

Modifications to embodiments of the present disclosure described in the foregoing are possible without departing from the scope of the present disclosure as defined by the accompanying claims. Expressions, such as “including”, “comprising”, “incorporating”, “have” and “is”, which we have used to describe and claim the present disclosure are intended to be construed in a non-exclusive manner, namely allowing for items, components or elements not explicitly described also to be present. Reference to the singular is also to be construed to relate to the plural. Reference to the male gender is intended also to comprehend the female gender.

Although we have described our disclosed embodiments in the context of particular embodiments, one of ordinary skill in this art will readily realize that many modifications may be made in such embodiments to adapt either to specific implementations. Thus it is apparent that we have provided a method and apparatus for teaching, that addresses, for example to overcome, the aforementioned drawbacks in existing methods and systems due to their inability to assess accurately the knowledge of a given learner on a topic and provide personalized lessons on the topic according to the learner's preferred mode of understanding. Further, we submit that our method and apparatus provide performance generally superior to the best prior art techniques.

What we claim is:

1. A method of teaching a student, Student_1, using an electronic data processing facility configured to execute a software program adapted to implement a selected machine learning algorithm, characterized in that the method comprises using the data processing facility to perform the steps of:
1.1 presenting to the Student_1 to a first content, Content_1;
1.2 developing a first behavioural pattern, Pattern_1, as a function of the physical reaction of the Student_1 to the Content_1, wherein the Pattern_1 comprises a selected one of an Emotional_State of the Student_1 and a Biometric measurement of the Student_1;
1.3 developing a first Query, Query_1, as a function of the Content_1 and the Pattern_1;
1.4 presenting to the Student_1 the Query_1;
1.5 receiving from the Student_1 a first Response, Response_1, to the Query_1; and
1.6 developing a first correctness metric, Correctness_1, as a function of the Content_1, the Pattern_1, the Query_1 and the Response_1.

2. The method of claim 1 further comprising the step of:
1.7 inferring, using the machine learning algorithm, a first comprehension inference, Comprehension_1, as a function of the Correctness_1, wherein the Comprehension_1 comprises an inference of the comprehension by the Student_1 of the Content_1.

3. The method of claim 2 further comprising the steps of:
1.8 developing, using the machine learning algorithm, a second content, Content_2, as a function of the Content_1, the Response_1, the Correctness_1, and the Pattern_1;
1.9 presenting to the Student_1 the Content_2;
1.10 developing a second behavioural pattern, Pattern_2, as a function of the physical reaction of the Student_1 to the Content_2, wherein the Pattern_2 comprises a selected one of an Emotional_State of the Student_1 and a Biometric measurement of the Student_1;
1.11 developing a second Query, Query_2, as a function of the Content_2 and the Pattern_2;
1.12 presenting to the Student_1 the Query_2;
1.13 receiving from the Student_1 a second Response, Response_2, to the Query_2; and
1.14 developing a second metric, Correctness_2, as a function of the Content_2, the Pattern_2, the Query_2 and the Response_2.

4. The method of claim 3 further comprising the step of:
1.15 inferring, using the machine learning algorithm, a second comprehension inference, Comprehension_2, as a function of the Correctness_1 and the Correctness_2, wherein the Comprehension_2 comprises an inference of the comprehension by the Student_1 of a selected one of the Content_1 and the Content_2.

5. The method of claim 4 further comprising the step of:
1.16 inferring, using the machine learning algorithm, a first model, Model_1, as a function of the Correctness_1 and the Correctness_2, wherein the Model_1 comprises a first inferred model of a preferred learning method of the Student_1.

6. The method of claim 5 further comprising the steps of:
1.17 developing, using the machine learning algorithm, a third content, Content_3, as a function of the Model_1;
1.18 presenting to the Student_1 the Content_3;
1.19 developing a third behavioural pattern, Pattern_3, as a function of the physical reaction of the Student_1 to the Content_3, wherein the Pattern_3 comprises a selected one of an Emotional_State of the Student_1 and a Biometric measurement of the Student_1;
1.20 developing a third Query, Query_3, as a function of the Content_3 and the Pattern_3;
1.21 presenting to the Student_1 the Query_3;
1.22 receiving from the Student_1 a third Response, Response_3, from the Student_1 to the Query_3; and
1.23 developing a third metric, Correctness_3, as a function of the Content_3, the Pattern_3, the Query_3 and the Response_3.

7. The method of claim 6 further comprising the step of:
1.24 inferring, using the machine learning algorithm, a third comprehension inference, Comprehension_3, as a function of the Correctness_1, the Correctness_2 and the Correctness_3, wherein the Comprehension_3 comprises an inference of the comprehension by the Student_1 of a selected one of the Content_1, the Content_2 and the Content_3.

8. The method of claim 7 further comprising the step of:
1.25 inferring, using the machine learning algorithm, a second model, Model_2, as a function of the Model_1, the Content_3, the Pattern_3, the Response_3 and the Correctness_3, wherein the Model_2 comprises a second inferred model of the preferred learning method of the Student_1.

9. The method of claim 1, wherein step 1.5 is further characterized as comprising the steps of:
1.5.1 receiving from the Student_1 the first Response, Response_1, to the Query_1; and
1.5.1 inferring, using the machine learning algorithm, a confidence inference, Confidence_1, as a function of a selected one of:
1.5.1.1 a time duration between the presentation to the Student_1 of the Query_1 and reception from the Student_1 of the Response_1;
1.5.1.2 a correctness of the Response_1; and
1.5.1.3 an attempt by the Student_1 to change the Response_1;
wherein the Confidence_1 comprises an inference of the confidence of the Student_1 in the quality of the Response_1.

10. The method of claim 9, wherein step 1.6 is further characterized as:
1.6 developing the first metric, Correctness_1, as a function of the Content_1, the Pattern_1, the Query_1, the Response_1 and the Confidence_1.

11. The method of claim 1 further comprising the following steps, interposed between steps 1.5 and 1.6:
1.26 presenting to the Student_1 a first request, Request_1, for a reason from the Student_1 for the Response_1; and
1.27 receiving from the Student_1 a first reason, Reason_1, in Response to the Request_1; and
wherein step 1.6 is further characterized as:
1.6 developing the first correctness metric, Correctness_1, as a function of the Content_1, the Pattern_1, the Query_1, the Response_1 and the Reason_1.

12. The method of claim 5 further comprising the following steps:
1.28 developing, using the machine learning algorithm, a fourth content, Content_4, as a function of the Model_1; and
1.30 presenting to the Student_1 the Content_4.

13. The method of claim 8 further comprising the following steps:
1.31 developing, using the machine learning algorithm, a fifth content, Content_5, as a function of the Model_2; and
1.32 presenting to the Student_1 the Content_5.

14. An electronic data processor facility configured to perform the method of claim 1.

15. An electronic data processing system comprising an electronic digital processor facility according to claim 14.

16. A non-transitory computer readable medium including executable instructions which, when executed in an electronic data processing system, causes the electronic data processing system to perform the steps of a method according to claim 1.
